(19) United States
(12) Patent Application Publication
(10) Pub. No.: US 2006/0103803 A1
(43) Pub. Date: May 18, 2006

(54) Panel for liquid crystal display, liquid crystal display including the panel, and methods for manufacturing the same

(76) Inventors: Baek-Kyun Jeon, Kyungki-do (KR); Sung-Wook Jung, Seoul (KR)

Correspondence Address: McGuireWoods, 1750 Tysons Boulevard, Suite 1800, McLean, VA, 22102, US

(21) Appl. No.: 10/523,017

(22) PCT Filed: Sep. 18, 2002
(86) PCT No.: PCT/KR02/01766

§ 371 Date: Sep. 15, 2005

(30) Foreign Application Priority Data
Aug. 2, 2002 (KR) 2002/45817

(51) Int. Cl. G02F 1/1339

(52) U.S. Cl. 349/155

(57) ABSTRACT

A liquid crystal display includes two substrates facing each other and having a display area. A sealant for supporting the substrates is formed along a periphery of the substrates located external to the display area and has a shape of a closed loop. A liquid crystal layer filled in a room enclosed by the substrates and the sealant. A plurality of spacers are formed between the substrates and contact the substrates with different contact areas to support the substrates. The contact area of the spacers contacting the two substrates becomes large as the spacers are located closer to a center of the display area.

### BACKGROUND OF THE INVENTION

(a) Field of the Invention

The present invention relates to a panel for a liquid crystal display, a liquid crystal display including the panel, and a manufacturing method thereof.

(b) Description of Related Art

Generally, a liquid crystal display (LCD) is a display device where a liquid crystal bearing dielectric anisotropy is sandwiched between two panels. Electric fields are applied to the liquid crystal by way of electrodes the transmittance of light passing through the panels are controlled by adjusting the field strength, thereby displaying desired picture images.

The LCD includes two panels with electrodes, and a liquid crystal sandwiched between the panels. The two panels are combined by a sealant printed along a periphery of the panel and encapsulating the liquid crystal. The two panels are supported by spacers spread between the two panels.

In a method of manufacturing an LCD, an alignment film for aligning liquid crystal molecules in the liquid crystal is coated on each of two panels and is subject to alignment treatment. Spherical spacers are spread on one of the panels, and a sealant is printed along the periphery of the panel such that the sealant has a hole for injecting liquid crystal. The two panels are aligned and attached to each other through hot press. A liquid crystal is injected between the two panels through the injection hole, and the injection hole is sealed to form a liquid crystal cell. Spacers for spacing the panels from each other are spread or formed on a display area corresponding to a screen area in a separate manner. Other spacers are added to the sealant to space the panels from each other.

A cell gap of a liquid crystal cell including two panels is measured at the center of the panels corresponding to the screen area as well as at the periphery thereof corresponding to the location of the sealant As the LCD has been large-sized, it becomes important to develop a technique of maintaining the cell gap between the two panels made of glass, plastic or ceramic in a constant manner.

### SUMMARY OF THE INVENTION

It is a motivation of the present invention to provide a panel for a display device, a liquid crystal display including the panel, and a manufacturing method thereof capable of maintaining a distance between two substrates constant.

A panel for a liquid crystal display and a manufacturing method thereof provide a plurality of spacers on a display area for contacting substrates to support the substrates such that the contact area increases as it goes to a center of the display area, thereby maintaining the distance between the two substrates constant.

Specifically, the panel for a liquid crystal display includes a plurality of spacers formed on an insulating substrate. The spacers contact the insulating substrate to support the substrates with different contact area.

It is preferable that the contact area increases as it goes to a center of the display area.

The panel for the liquid crystal display may further include a gate wire and a data wire formed on the insulating substrate and transmitting electrical signals such as a scanning signal and a picture signal, a thin film transistor electrically connected to the gate wire and the data wire and serving as a switching element for controlling the picture signal, and a pixel electrode receiving a pixel voltage for drive liquid crystal molecules. The panel may further include red, green and blue color filters.

A liquid crystal display is also provided, which includes: two substrates facing each other and having a display area; a sealant formed along a periphery of the substrates located external to the display area, having a shape of a closed loop, and supporting the substrates; a liquid crystal layer filled in a room enclosed by the substrates and the sealant; and a plurality of spacers formed between the substrates and contacting the substrates with different contact areas to support the substrates.

The contact area of the spacers contacting the substrate preferably becomes large as the spacers are located doser to a center of the display area.

A method of manufacturing a liquid crystal display drops a liquid crystal material on one of two substrates to form a liquid crystal layer, and combines the two substrates under vacuum atmosphere.

### BRIEF DESCRIPTION OF THE DRAWINGS

FIGS. 1A and 1B are graphs illustrating the cell gap of a liquid crystal panel manufactured by vacuum press process at the display area thereof;

FIG. 2 is a table illustrating the variation in a liquid crystal cell as a function of the sectional area of a spacer in an experiment of the present invention;

FIG. 3 is a plan view of a liquid crystal panel for an LCD according to an embodiment of the present invention;

FIG. 4 is a sectional view of the liquid crystal panel shown in FIG. 3 taken along the line IV-IV′; and

FIG. 5 illustrates the location of the spacers in the display area of the unit liquid crystal cell.

### DETAILED DESCRIPTION OF PREFERRED EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers, films and regions are exaggerated for clarity. Like numerals refer to like elements throughout It will be understood that when an element such as a layer, film, region or substrate is referred to as being “on” another element, it can be directly on the other element or intervening elements may also be present. In contrast, when an element is referred to as being “directly on” another element, there are no intervening elements present.

Now, panels for a liquid crystal display, liquid crystal displays including the panel, and manufacturing methods thereof according to embodiments of the present invention will be described with reference to the accompanying drawings.

A method of manufacturing an LCD includes a hot press process attaching two substrates by adhering the substrates to plates and pressing the plates, and a vacuum press process attaching two substrates by keeping a room enclosed by the substrates and the sealant to be in a vacuum state and exposing the substrates to atmosphere. In a liquid crystal panel manufactured by the vacuum press process, the periphery of the display area is supported by a sealant containing solid spacers with small elasticity, while most of the display area is supported by spacers having excellent elasticity. When external atmospheric pressure is uniformly applied to entire surface of the substrates with keeping the inner room enclosed by the substrates and the sealant to be in a vacuum state, the distance between the substrates at the center of the display area becomes reduced to make the cell gap between the substrates non-uniform. This will be now described with reference to the drawings.

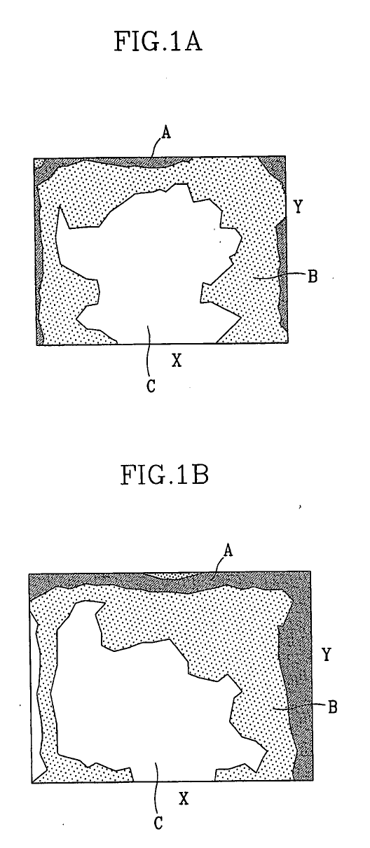

FIGS. 1A and 1B are graphs illustrating the cell gap of a liquid crystal panel manufactured by vacuum press process at the display area thereof. In the figures, the horizontal axis X indicates the horizontal direction in the liquid crystal panel, and the vertical axis Y indicates the vertical direction in the liquid crystal panel.

As shown in FIGS. 1A and 1B, the measured cell gap is 4.6-4.8 microns at the periphery A of the display area, 4.4-4.5 microns at the center C of the display area, and 4.5-4.6 microns at the area between the periphery A of the display area and the center C thereof. That is, the measured cell gap of the liquid crystal panel is non-uniform.

Experiments of the present invention evaluated effect of sectional area of spacers supporting substrates on a cell gap. A plurality of cubic spacers were formed by photolithography, and one spacer is assigned to every twelve pixels. The surface area of the spacer supporting substrates was 18.8×18.8 square microns, 23.0×23.0 square microns, and 26.6×26.6 square microns. The liquid crystal layer of the liquid crystal panel was formed by dropping liquid crystal material on the substrate. The two substrates were attached to each other by vacuum press. The initial value of the cell gap was 4.6 microns. The dropped amount of the liquid crystal material was 97% of a predetermined effective volume. The cell gap was measured at the location distant from a sealant by 0 mm, 6 mm, 12 mm, 18 mm, and 24 mm.

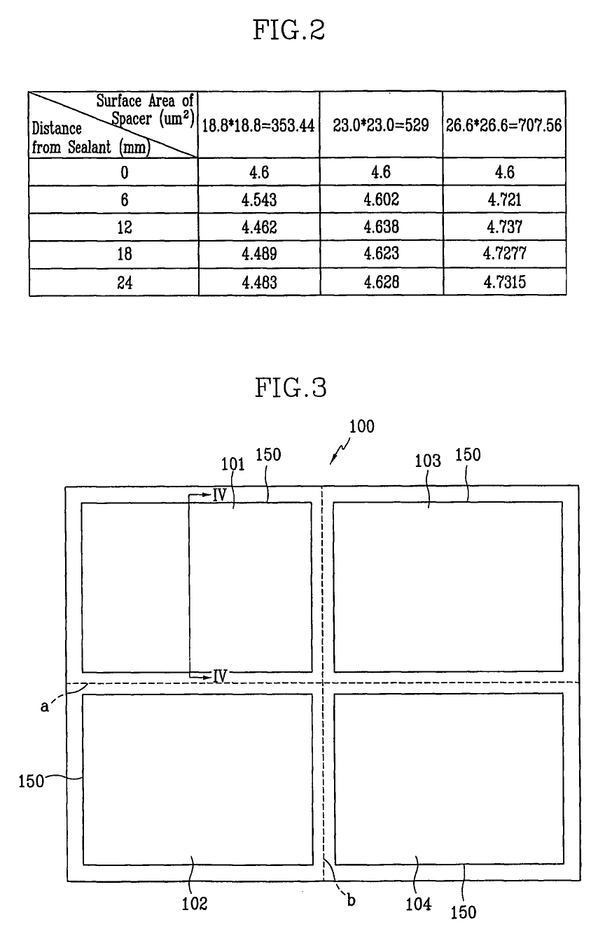

FIG. 2 is a table illustrating the variation in a liquid crystal cell as a function of the sectional area of a spacer in the experiment of the present invention.

As shown in FIG. 2, when the cell gap for all cases was established to be 4.6 microns at any place, the measured cell gap at the periphery of the liquid crystal panel provided with the sealant was kept to be 4.6 microns for all cases. The measured cell gap is reduced as the surface area of the spacer supporting the substrates is decreased. That is, the measured cell gap increases as the supporting area of the spacer for the substrates is increased. It turned out that the cell gap could be kept uniform by increasing the contact area of the spacer to the substrates.

There are several factors of exerting an influence on the cell gap, such as the amount of the liquid crystal material, and height and density of the spacers. Since the factors other than the amount of the liquid crystal material and the contact area of the spacer to the substrates hardly influence on the cell gap, the cell gap was measured as function of the amount of the liquid crystal material and the surface area of the spacer. The measured cell gap lies within 4.6±0.15 microns, which includes allowable error, in case the smallest surface area of the spacer was equal to 15×15 square microns and the amount of the liquid crystal material was equal to 96% and in case the largest surface area of the spacer was equal to 30×30 square microns and the amount of the liquid crystal material was equal to 98%. Therefore, in order to maintain the cell gap constant, it is preferable that the ratio of the largest surface area to the smallest surface area of the spacers is equal to or less than 3.

A liquid crystal panel for an LCD and a manufacturing method thereof using dropping technique will be now described in detail.

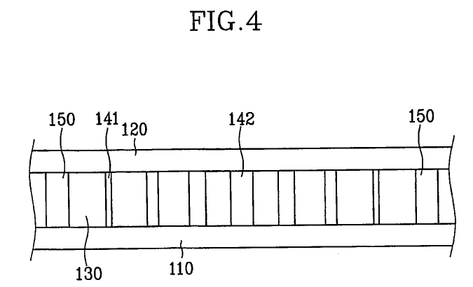

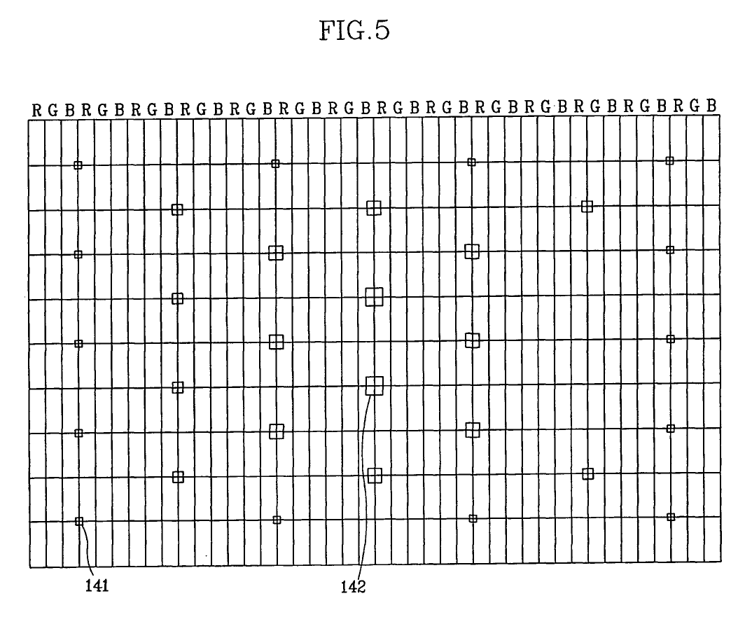

FIG. 3 is a plan view of a liquid crystal panel for an LCD according to an embodiment of the present invention, FIG. 4 is a sectional view of the liquid crystal panel shown in FIG. 3 taken along the line IV-IV′, and FIG. 5 illustrates the location of the spacers in the display area of the unit liquid crystal cell.

As shown in FIGS. 3 and 4, a liquid crystal panel 100, which is a single panel after suffering the steps of liquid crystal injection and substrate combination according to an embodiment of the present invention, includes a plurality of liquid crystal cells. For example, as shown in the figures, the liquid crystal panel 100 includes two insulating substrates 110 and 120, and liquid crystal layers 130 interposed between the two substrates 110 and 120. Four liquid crystal cell areas indicated by dotted lines a and b are formed in the liquid crystal panel 100. Each of the cell areas has a display area 101, 102, 103 or 104 for displaying images. A plurality of spacers 141 and 142 for maintaining the substrates 110 and 120 to be parallel are formed in the liquid crystal panel 100. A sealant 150 is formed along the periphery of each the cell area and the liquid crystal layer 130 is sealed by the sealant 150.

As shown in FIG. 5, the spacers 141 and 142 contact the substrates 110 and 120 to support the substrates 110 and 120 and their contact areas are different. The contact area of the spacers 141 and 142 with the substrates 110 and 120 becomes larger as it goes from edges of the display area 101-104 adjacent to the sealant 150 to the center of the display area 101-104. However, it is preferable that the contact area of the spacer 142 at the center of the display area 101-104 is equal to or less than 3.2 times the contact area of the spacer 141 closest to the edges of the display area 101-104.

Meanwhile, the sealant 150 may contain spacers for supporting the substrates 110 and 120 to be parallel to each other.

In a method of manufacturing the LCD, the liquid crystal panel 100 may be provided with the liquid crystal layer 130 before or after it is separated into the liquid crystal cells. The reference signs a and b indicate cutting lines for separating the liquid crystal panel into the cell areas after the liquid crystal injection and the substrate combination are completed.

One of the substrates 110 and 120 of the liquid crystal panel 100 is provided with a plurality of gate wires and a plurality of data wires crossing each other to define pixel areas and transmitting electrical signals such as scanning signals or picture signals, a plurality of thin film transistors electrically connected to the gate wires and the data wires and functioning as switching elements for controlling the picture signals, and a plurality of pixel electrodes receiving pixel voltages for driving the liquid crystal molecules. This becomes to be thin film transistor array panels. The other substrate 120 is provided with a common electrode facing the pixel electrodes to generate electric fields for driving the liquid crystal molecules, and a plurality of red (R), green (G) and blue (B) color filters sequentially formed in the pixel areas. This becomes to be the counter panels. The color filters or the common electrode may be formed on the thin film transistor array panel.

A method of manufacturing a liquid crystal panel for an LCD will be now described in detail.

A plurality of low resistant gate wire, a plurality of low resistant data wire, a plurality of thin film transistors, and a plurality of pixel electrodes made of a transparent conductive material or a reflective conductive material are formed on an original substrate 110 of a liquid crystal panel 100. An organic insulating material is deposited on the substrate 110 and patterned by photo-etching to form a plurality of spacers 141 and 142. The spacers 141 and 142 are placed between the pixel areas. Meanwhile, a common electrode and a plurality of red, green and blue color filters are formed on the other substrate 120. As described above, the color filters or the common electrode may be formed on the substrate along with the thin film transistors. It is preferable that the size of the spacers 141 and 142 is equal to about 10-30% of the distance between the substrates 110 and 120 of the liquid crystal panel 100. The spacers 141 and 142 may be formed on any one of the substrates 110 and 120. The formation of the spacers 141 and 142 using photolithography enables to uniformly arrange the spacers 141 and 142 such that the cell gap can be uniformly made throughout the panel 100, to obtain thin cell gap, and to prevent the spacers 141 and 142 from being placed on the pixel areas, thereby improving the display characteristics.

Thereafter, a sealant 150 is coated on one of the substrates 110 and 120 provided with the spacers 141 and 142. The sealant 150 forms a closed loop without an injection hole for injecting liquid crystal. The sealant 150 may be made of thermosetting material or ultraviolet-hardening material. The sealant 150 may contain a plurality of spacers for keeping the gap between the substrates 110 and 120. Since the sealant 150 has no injection hole, it is important to exactly control the amount of the liquid crystal material. In order to solve any problem made in case the amount of the liquid crystal is too much or too small, a buffer region without liquid crystal material even after the termination of the substrate combination is preferably provided at the sealant 150. Meanwhile, it is preferable that the sealant 150 has an anti-reaction film on its surface, which is not reactant with the liquid crystal layer 130.

A liquid crystal material is coated or dropped on any one of the substrates 110 and 120 using a liquid crystal coater. The liquid crystal coater may bear a dice shape such that it can drop the liquid crystal material at the liquid crystal cell areas 101-104. The liquid crystal may be sprayed on the entire surface of the liquid crystal cell areas 101-104. In this case, the liquid crystal coater bears the shape of a sprayer.

The substrates 110 and 120 are delivered to an assembly device of a vacuum chamber. The room surrounded by the substrates 110 and 120 and the sealant 150 is evacuated to be in a vacuum state, and the substrates 110 and 120 are closely adhered to each other using atmospheric pressure such that the distance between the substrates 110 and 120 reaches the desired cell gap. The sealant 150 is completely hardened with the illumination of an UV ray using a light exposing device. In this way, the two substrates 110 and 120 are combined, thereby completing the formation of a liquid crystal panel 100. The two substrates 110 and 120 are exactly aligned to a minute order during the step of adhering the substrates 110 and 120 and the step of illuminating UV ray on the sealant 150. The periphery of the display area 101-104 of the substrates 110 and 120 is supported by the sealant 150 containing spacers with small elasticity, while most of the display area 101-104 is supported by the spacers 141 and 142 having excellent elasticity. When external atmospheric pressure is uniformly applied to entire surface of the substrates with keeping the inner room enclosed by the substrates 110 and 120 and the sealant 150 to be in a vacuum state, the distance between the substrates 110 and 120 at the center of the display area 101-104 becomes reduced to make the cell gap between the substrates 110 and 120 non-uniform if the contact areas of the spacers 141 and 142 equal to each other. In order to solve such a problem, the present invention makes the contact area of the spacers 141 and 142 with the substrates 110 and 120 become larger as it goes from edges of the display area 101-104 adjacent to the sealant 150 to the center of the display area 101-104. However, it is preferable that the contact area of the spacer 142 at the center of the display area 101-104 is equal to or less than 3.2 times the contact area of the spacer 141 closest to the edges of the display area 101-104.

The liquid crystal panel 100 is separated into the liquid crystal cell areas 101-104 using a scribing machine.

As described above, the present invention makes the area of the spacer supporting the substrates become enlarged as it goes to the center of the display area, so that the cell gap can be maintained constant.

What is claimed is:

1. A panel for a liquid crystal display, the panel comprising:
an insulating substrate with a display area; and
a plurality of spacers formed on the insulating substrate and contacting the insulating substrate to support the insulating substrate,
wherein contact area of the spacers contacting the substrate becomes large as the spacers are located closer to a center of the display area.

2. The panel of claim 1, wherein the contact area of the spacers at the center of the display area is equal to or less than 3.2 times the contact area of the spacers closest to edges of the display area.

3. The panel of claim 2, further comprising a gate wire and a data wire formed on the insulating substrate and transmitting electrical signals such as a scanning signal and a picture signal, a thin film transistor electrically connected to the gate wire and the data wire and serving as a switching element for controlling the picture signal, and a pixel electrode receiving a pixel voltage for drive liquid crystal molecules.

4. The panel of claim 2, further comprising red, green and blue color filters formed on the insulating substrate.

5. A liquid crystal display comprising:
two substrates facing each other and having a display area;
a sealant formed along a periphery of the substrates located external to the display area, having a shape of a closed loop, and supporting the substrates;
a liquid crystal layer filled in a room enclosed by the substrates and the sealant; and
a plurality of spacers formed between the substrates and contacting the substrates with different contact areas to support the substrates.

6. The liquid crystal display of claim 5, wherein contact area of the spacers contacting the substrate becomes large as the spacers are located closer to a center of the display area.

7. The liquid crystal display of claim 6, wherein the contact area of the spacers at the center of the display area is equal to or less than 3.2 times the contact area of the spacers closest to edges of the display area.

8. A method of manufacturing a liquid crystal display, the method comprising:
forming a plurality of spacers on one of two substrates having display areas, the spacers located on the display area of the one of two substrates and contacting the substrate with different contact areas to supporting the substrate;
applying a sealant on one of the substrates;
dropping a liquid crystal material on the substrate applied with the sealant; and
combining the substrates under a vacuum atmosphere.

9. The method of claim 8, wherein contact area of the spacers contacting the substrate becomes large as the spacers are located closer to a center of the display area.

10. The method of claim 9, wherein the combination of the substrates comprises:
aligning the substrates;
evacuating a room between the substrates;
adhering the substrates using vacuum atmosphere;
pressurizing the substrates using atmospheric pressure;
attaching the substrates with the sealant; and
combining the substrates by hardening the sealant.

11. The method of claim 10, wherein the contact area of the spacers at the center of the display area is equal to or less than 3.2 times the contact area of the spacers closest to edges of the display area when combining the substrates.
